(19) United States
(12) Patent Application Publication
(10) Pub. No.: US 2024/0064311 A1
(43) Pub. Date: Feb. 22, 2024

(54) A METHOD, AN APPARATUS AND A COMPUTER PROGRAM PRODUCT FOR ENCODING AND DECODING

(71) Applicant: Nokia Technologies Oy, Espoo (FI)

(72) Inventors: Pekka ASTOLA, Tampere (FI); Alireza AMINLOU, Tampere (FI); Jani LAINEMA, Tampere (FI)

(21) Appl. No.: 18/259,765

(22) PCT Filed: Dec. 17, 2021
(86) PCT No.: PCT/FI2021/050891

§ 371 Date: Jun. 28, 2023

(30) Foreign Application Priority Data
Dec. 29, 2020 (FI) 20206379

(51) Int. Cl. H04N 19/167; H04N 19/186; H04N 19/59

(52) U.S. Cl. CPC H04N 19/167; H04N 19/186; H04N 19/59

(57) ABSTRACT

The embodiments relate to a method comprising obtaining sample values of a target area in a picture to be encoded (310); obtaining sample values of a regressor area in a picture to be encoded (320); determining at least one set of prediction coefficients by means of a linear regression (330); predicting the sample values of the target area using the determined at least one set of prediction coefficients to result in a first predicted sample values (340); determining best performing set of prediction coefficients (350); predicting the sample values of the target area using the best performing set of prediction coefficients (360); encoding an indication indicating the best performing set of prediction coefficients along the bitstream (370), and iterating the steps for all target areas in the picture to be encoded (380). The embodiments also relate to a decoding method, and apparatuses for encoding and decoding.

### TECHNICAL FIELD

The present solution generally relates to coding and decoding of digital media content, such as video or still image data.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided a method comprising obtaining sample values of a target area in a picture to be encoded; obtaining sample values of a regressor area in a picture to be encoded; determining at least one set of prediction coefficients by means of a linear regression; predicting the sample values of the target area using the determined at least one set of prediction coefficients to result in a first predicted sample values; determining best performing set of prediction coefficients; predicting the sample values of the target area using the best performing set of prediction coefficients; encoding an indication indicating the best performing set of prediction coefficients or other parameters indicating the active coefficients along the bitstream, and iterating the steps for all target areas in the picture to be encoded.

According to a second aspect, there is provided an apparatus comprising means for obtaining sample values of a target area in a picture to be encoded; means for obtaining sample values of a regressor area in a picture to be encoded; means for determining at least one set of prediction coefficients by means of a linear regression; means for predicting the sample values of the target area using at least the determined at least one set of prediction coefficients to result in a first predicted sample values; means for determining best performing set of prediction coefficients; means for predicting the sample values of the target area using the best performing set of coefficients; means for encoding an indication indicating the best performing set of prediction coefficients or other parameters indicating the active coefficients along the bitstream, and means for iterating the steps for all target areas in the picture to be encoded.

According to a third aspect, there is provided an apparatus comprising at least one processor, memory including computer program code, the memory and the computer program code configured to, with the at least one processor, cause the apparatus to perform at least the following: obtain sample values of a target area in a picture to be encoded; obtain sample values of a regressor area in a picture to be encoded; determine at least one set of prediction coefficients by means of a linear regression; predict the sample values of the target area using the determined at least one set of prediction coefficients to result in a first predicted sample values; determine best performing set of prediction coefficients; predict the sample values of the target area using the best performing set of prediction coefficients; encode an indication indicating the best performing set of prediction coefficients or other parameters indicating the active coefficients along the bitstream, and iterate the steps for all target areas in the picture to be encoded.

According to a fourth aspect, there is provided a method comprising: obtaining sample values of a regressor area of an encoded picture; decoding an indication indicating best performing set of prediction coefficients or other parameters indicating the active coefficients along the bitstream; obtaining a set of prediction coefficients corresponding to the decoded indication; using the set of prediction coefficients to predict sample values in a target area of the encoded picture; and iterating the steps for all target areas of the encoded picture to reconstruct a decoded picture from the predicted sample values.

According to a fifth aspect, there is provided an apparatus comprising means for obtaining sample values of a regressor area of an encoded picture; means for decoding an indication indicating best performing set of prediction coefficients or other parameters indicating the active coefficients along the bitstream; means for obtaining a set of prediction coefficients corresponding to the decoded indication; means for using the set of prediction coefficients to predict sample values in a target area of the encoded picture; and means for iterating the steps for all target areas of the encoded picture to reconstruct a decoded picture from the predicted sample values.

According to sixth aspect, there is provided an apparatus comprising at least one processor, memory including computer program code, the memory and the computer program code configured to, with the at least one processor, cause the apparatus to perform at least the following: obtain sample values of a regressor area of an encoded picture; decode an indication indicating best performing set of prediction coefficients or other parameters indicating the active coefficients along the bitstream; obtain a set of prediction coefficients corresponding to the decoded indication; use the set of prediction coefficients to predict sample values in a target area of the encoded picture; and iterate the steps for all target areas of the encoded picture to reconstruct a decoded picture from the predicted sample values.

According to an embodiment, the target area is a set of sample values covering spatially equal areas at an encoder and a decoder in a color component.

According to an embodiment, the regressor area is a set of sample values covering spatially equal areas at an encoder and a decoder in one or more color components.

According to an embodiment, size and shape of the target area; and size, shape and location of the regressor area are decided.

According to an embodiment, the best performing set of coefficients is determined from said at least one set of prediction coefficients.

According to an embodiment, picture component is inherited from another picture component.

According to an embodiment, further comprising means for predicting the sample values of the target area using sets of coefficients stored in a predictor library.

According to an embodiment, the best performing set of coefficients is determined from the predictor library storing past sets of coefficients.

### DESCRIPTION OF THE DRAWINGS

In the following, various embodiments will be described in more detail with reference to the appended drawings, in which

FIG. 1 shows an example of an encoding process;

FIG. 2 shows an example of a decoding process;

FIG. 3 is a flowchart illustrating a method according to an example embodiment;

FIG. 4 is a flowchart illustrating a method according to another example embodiment; and

FIG. 5 shows an apparatus according to an example embodiment;

FIG. 6 shows an example of target and regressor areas;

FIG. 7 shows an example of a causal predictor template; and

FIG. 8 shows an example of a spatially non-causal predictor template.

### DESCRIPTION OF EXAMPLE EMBODIMENTS

In the following, several embodiments will be described in the context of one video coding arrangement. It is to be noted, however, that the present embodiments are not necessarily limited to this particular arrangement. The embodiments discussed in this specification relates to intra prediction in video or still image coding using sparse linear cross-component regression.

Video codec comprises an encoder and a decoder. The encoder is configured to transform input video into a compressed representation suitable for storage/transmission. The decoder is able to decompress the compressed video representation back into a viewable form. The encoder may discard some information in the original video sequence in order to represent the video in a more compact form, for example at a lower bitrate.

An elementary unit for the input to an encoder and the output of a decoder, respectively, in most cases is a picture. A picture given as an input to an encode may also be referred to as a source picture, and a picture decoded by a decoder may be referred to as a decoded picture or a reconstructed picture.

The source and decoded picture are each comprised of one or more sample arrays, such as one of the following sets of sample arrays:
Luma (Y) only (monochrome);
Luma and two chroma (YCbCr or YCgCo);
Green, Blue and Red (GBR, also known as RGB);
Arrays representing other unspecified monochrome or tri-stimulus color samplings (for example, YZX, also known as XYZ).

A picture may be defined to be either a frame or a field. A frame comprises a matrix of luma samples and possibly the corresponding chroma samples. A field is a set of alternate sample rows of a frame, and may be used as encoder input, when the source signal is interlaced. Chroma sample arrays may be absent (and hence monochrome sampling may be in use) or chroma sample arrays may be subsampled when compared to luma sample arrays.

A bitstream may be defined as a sequence of bits, which may in some coding formats or standards be in the form of a network abstraction layer (NAL) unit stream or a byte stream, that forms the representation of coded pictures and associated data forming one or more coded video sequence. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of the bitstream (EOB) NAL unit and which is the last NAL unit of the bitstream.

The phrase “along the bitstream” (e.g. indicating along the bitstream) or along a coded unit of a bitstream (e.g. indicating along a coded tile) may be used in claims and described embodiments to refer to transmission, signaling or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signalling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Hybrid video codecs, for example ITU-T H.263 and H.264 may encode video information in two phases. At first, pixel values in a certain picture area (or “block”) are predicted for example by motion compensation means (finding and indicating an area in one of the previously coded video frames that correspond closely to the block being coded) or by spatial means (using the pixel values around the block to be coded in a specified manner). In the first phase, predictive coding may be applied, for example, as so-called sample prediction and/or so-called syntax prediction. In the sample prediction, pixel of sample values in a certain picture area or “block” are predicted. These pixel or sample values can be predicted, for example, using one or more of motion compensation or intra prediction mechanism. Secondly, the prediction error, i.e. the difference between the predicted block of pixels and the original bock of pixels is coded. This may be done by transforming the difference in pixel values a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

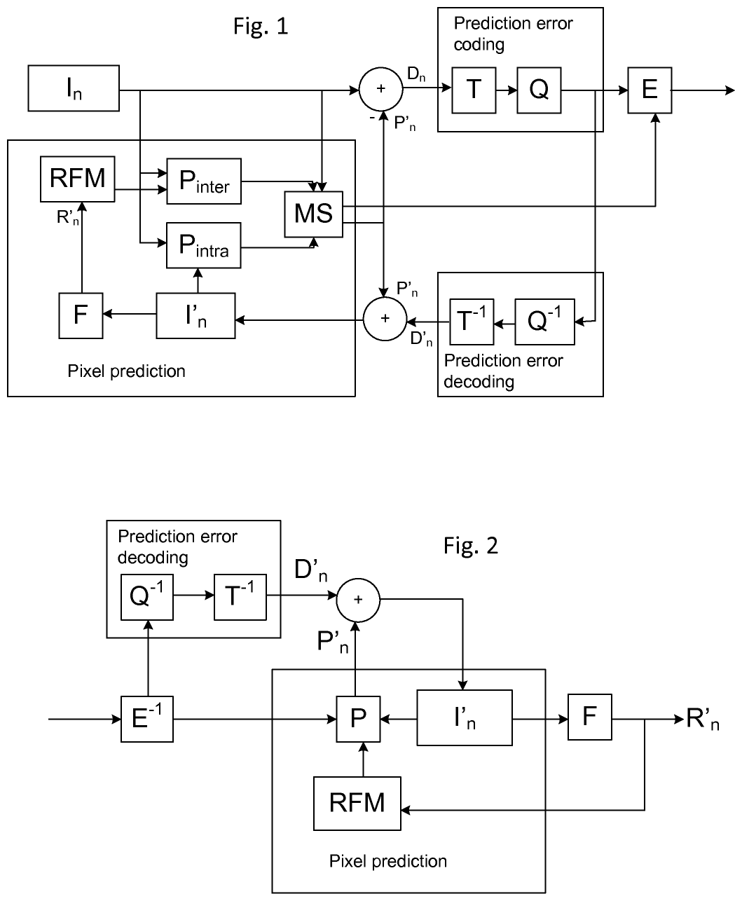

The example of the encoding process is illustrated in FIG. 1. FIG. 1 illustrates an image to be encoded (Iₙ); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ), mode selection (MS) and filtering (F).

In some video codecs, such as H.265/HEVC, video pictures are divided into coding units (CU) covering the area of the picture. A CU comprises one or more prediction units (PU) defining the prediction process for the samples within the CU and one or more transform units (TU) defining the prediction error coding process for the samples in said CU. A CU may comprise a square block of samples with a size selectable from a predefined set of possible CU sizes. A CU with the maximum allowed size may be named as LCU (largest coding unit) or CTU (coding tree unit), and the video picture may be divided into non-overlapping CTUs. A CTU can be further split into a combination of smaller CUs, e.g. by recursively splitting the CTU and resultant CUs. Each resulting CU may have at least one PU and at least one TU associated with it. Each PU and TU can be further split into smaller PUs and TUs in order to increase the granularity of the prediction and prediction error coding processes, respectively. Each PU has prediction information associated with it, defining what kind of a prediction is to be applied for the pixels within that PU (e.g. motion vector information for inter predicted PUs and intra prediction directionality information for intra predicted PUs). Similarly, each TU is associated with information describing the prediction error decoding process for the samples within said TU (including e.g. DCT coefficient information). It may be signalled at CU level, whether prediction error coding is applied or not for each CU. In the case there is no prediction error residual associated with the CU, it can be considered there are no Tus for said CU. The division of the image into CUs, and division of CUs into PUs and TUs may be signaled in the bitstream allowing the decoder to reproduce the intended structure of these units.

The decoder may reconstruct the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder is configured to sum up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. An example of a decoding process is illustrated in FIG. 2. FIG. 2 illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

Instead, or in addition to approaches utilizing sample value prediction and transform coding for indicating the coded sample values, a color palette-based coding can be used. Palette based coding refers to a family of approaches for which a palette, i.e. a set of colors and associated indexes, is defined and the value for each sample within a coding unit is expressed by indicating its index in the palette. Palette based coding can achieve good coding efficiency in coding units with a relatively small number of colors (such as image areas which are representing computer screen content, for example text or simple graphics). In order to improve the coding efficiency of palette coding, different kinds of palette index prediction approaches can be utilized, or the palette indexes can be run-length coded to be able to represent larger homogenous areas efficiently. Also, in the case the CU contains sample values that are not recurring within the CU, escape coding can be utilized. Escape coded samples are transmitted without referring to any of the palette indexes. Instead their values may be indicated individually for each escape coded sample.

When a CU is coded in palette mode, the correlation between pixels within the CU is exploited using various prediction strategies. For example, mode information can be signaled for each row or pixels that indicates one of the following: the mode can be horizontal mode meaning that a single palette index is signaled and the whole pixel line shares this index; the mode can be vertical mode, where the whole pixel line is the same with the above line, and no further information is signaled; the mode can be normal mode where a flag is signaled for each pixel position to indicate whether it is the same with one of the left and other pixels—and if not, the color index itself is separately transmitted.

In video codecs, the motion information may be indicated with motion vectors associated with each motion compensated image block. Each of these motion vectors may represent the displacement of the image block in the picture to be coded (at the encoder side) or decoded (at the decoder side), and the prediction sources block in one of the previously coded or decoded pictures. In order to represent motion vectors efficiently, those may be coded differentially with respect to block specific predicted motion vectors. In video codecs, the predicted motion vectors may be created in a predefined way, for example calculating the media of the encoder or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information may be signaled among a list of motion field candidate list filled with motion field information of available adjacent/co-located blocks.

Video codecs may support motion compensated prediction from one source image (uni-prediction) and two sources (bi-prediction). In the case of uni-prediction, a single motion vector may be applied whereas in the case of bi-prediction, two motion vectors may be signaled and the motion compensated predictions from two sources may be averaged to create the final sample prediction. In the case of weighted prediction, the relative weights of the two predictions can be adjusted, or a signaled offset can be added to the prediction signal.

In addition to applying motion compensation for inter picture prediction, similar approach can be applied to intra picture prediction. In this case the displacement vector indicates where a block of samples can be copied from the same picture to form a prediction of the block to be coded or decoded. This kind of intra block copying methods can improve the coding efficiency substantially in presence of repeating structures within the frame—such as text or other graphics.

In video codecs, the prediction residual after motion compensation or intra prediction may be first transformed with a transform kernel (like DCT “Discrete-Cosine Transform”) and then coded. The reason for this is that often there still exists some correlation among the residual and transform can in many cases help reduce this correlation and provide more efficient coding.

Video encoders may utilize Lagrangian cost functions to find optimal coding modes, e.g. the desired macroblock mode and associated motion vectors. This kind of cost function uses a weighting factor 2 to tie together the (exact or estimated) image distortion due to lossy coding methods and the (exact or estimated) amount of information that is required to represent the pixel values in an image area:

C=D+λR (Eq. 1)

where C is the Lagrangian cost to be minimized, D is the image distortion (e.g. Mean Squared Error) with the mode and motion vectors considered, and R is the number or bits needed to represent the required data to reconstruct the image block in the decoder (including the amount of data to represent the candidate motion vectors).

Scalable video coding refers to coding structure where one bitstream can contain multiple representation of the content at different bitrates, resolutions or frame rates. In these cases, the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may comprise a “base layer” providing the lowest quality video available and one or more enhancement layers that enhance the video quality when received and decoded together with the lower layers. In order to improve the coding efficiency for the enhancement layers, the coded representation of that layer may depend on the lower layers. E.g. the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codec using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and may indicate its use with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, following scalability modes exist:
Spatial scalability: Base layer pictures are coded at a lower resolution than enhancement layer pictures.
Bit-depth scalability: Base layer pictures are coded at lower bit-depth (e.g. 8 bits) than enhancement layer picture (e.g. 10 or 12 bits).
Chroma format scalability: Enhance layer picture provide higher fidelity in chroma (e.g. coded in 4:4:4 chroma format) than base layer picture (e.g. 4:2:0 format).

In the aforementioned scalability cases, base layer information can be used to code enhancement layer to minimize the additional bitrate overhead.

Scalability can be enabled in two ways: a) by introducing new coding modes for performing prediction of pixel values or syntax from lower layers of the scalable representation; or b) by placing the lower layer pictures to the reference picture buffer (decoded picture buffer, DPB) of the higher layer. Approach a) is more flexible, and thus can provide better coding efficiency in most cases. However, the approach b), i.e. the reference frame-based scalability, can be implemented very efficiently with minimal changes to single layer codecs while still achieving majority of the coding efficiency gains available. A reference frame-based scalability codec can be implemented by utilizing the same hardware or software implementation for all the layers, just taking care of the DPB management by external means.

In order to be able to utilize parallel processing, images can be split into independently codable and decodable image segments (slices or tiles). Slices may refer to image segments constructed of certain number of basic coding units that are processed in default coding or decoding order, while tiles may refer to image segments that have been defined as rectangular image regions that are processed at least to some extent as individual frames.

A video may be encoded in YUV or YCbCr color space that is found to reflect some characteristics of the human visual system and allows using lower quality representation for Cb and Cr channels as human perception is less sensitive to the chrominance fidelity those channels represent.

Capture and transmission of digital video and still image data requires both high bandwidth and large storage capacity. For transmission and storing purposes, video frame sand still images are represented in coded form. The efficiency of the coded representation depends on how well the redundancies of the video and image data can be utilized. A video or still image coding algorithm needs to model the data as precisely as possible in order to maximally utilize spatial redundancy. Methods, such as copying of earlier sample values (or blocks), and prediction of whole blocks using fixed interpolators have been widely used in the industry to capture the redundancy in video and still image data. However, such methods are not satisfactory in the more precise modelling of the image data when the complex structures such as natural textures appear. Larger predictive models (with dozens or hundreds of variables) can be used to represent more complex textured image data. In order to apply these more complex predictive models in practical coding systems, the code length of the prediction model (i.e., prediction coefficients) needs to be minimized while maintaining the prediction accuracy.

Fixed causal and sequential linear predictions are utilized in video and image coding systems even at the level of standards. However, adaptive linear predictors and sparse predictors are more rarely used.

In the following term “encoder” refers to both video and still image encoder. Similarly, term “decoder” refers to both video and still image decoder. An encoder or a decoder, according to example embodiments, performs iterative sparse linear regression using any linear regression method on a previously decoded area in order to obtain at least one causal linear predictor that models the underlying 2D auto-regressive (AR) process of the image or video frame.

An encoder or a decoder according to example embodiments, may perform iterative sparse linear regression using any linear regression method on a previously decoded color component area in order to obtain at least one causal linear predictor (i.e., moving average (MA) predictor) that exploits the cross-component correlation of the image or video frame. The term “color” refers to an individual color component, such as RGB, YCbCr, or other, for example a multi-spectral component.

An encoder or a decoder according to example embodiments, may perform two-dimensional prediction of the target block by using linear prediction based on 1) the sparse AR model; 2) the sparse MA model, or 3) the combined sparse ARMA (auto-regressive moving-average) model.

An encoder or a decoder according to example embodiments, may store the linear prediction into a library of predictors. The predictors in the library can be used in prediction of later target areas to further exploit the non-local redundancy in the image or video frame without the need of explicit signalling of the predictor coefficients. The library is updated on-line during encoding and decoding after processing either a single block (such as a CU) or a pre-defined number of blocks (such as a CTU).

An encoder according to example embodiments, may signal the index of the predictor library in an optimized way by iteratively sorting the library elements using one of the several proposed methods

An encoder according to example embodiments may signal the number of non-zero prediction coefficients (in the AR, MA or ARMA predictor) as a sparsity number. The decoder will use the same linear regression method, regressor area and the sparsity number to obtain the linear predictor. The linear predictor is used to predict the sample values in the target area. The encoder does not explicitly send the prediction coefficients since they can be reconstructed based on the sparsity number.

The present embodiments relate to advantageous implementation of the prediction scheme, including the storing of the obtained linear predictors into predictor library that can be utilized to better capture the redundancy in the video or image data, inheritance of the sparsity number between color components, improved signalling of the sparsity number based on decoder-side inference, selection of the regression method from several candidate methods, and the use of cross-component linear predictive modelling for exploiting correlation in a selected colorspace.

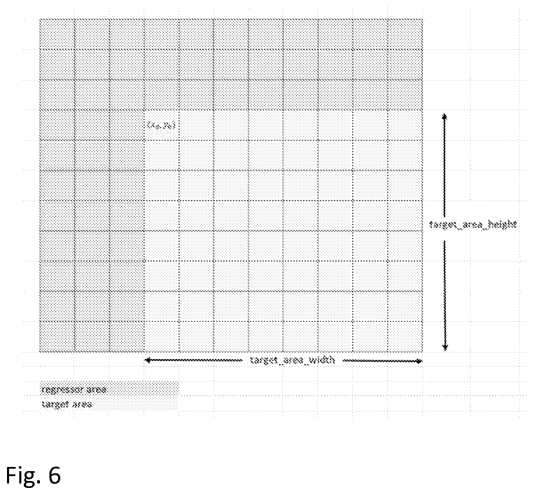

In the following, operations of the encoder according to example embodiments is discussed in more detailed manner. The encoder, according to an example, is configured to:
1. obtain sample values of a target area of a picture, wherein the target area is a block or a region of a picture, see FIG. 6;
2. obtain sample values of a regressor area of a picture, wherein the regressor area represents block(s) or region(s) of a picture, see FIG. 6;
3. obtain at least one set of prediction coefficients using a method of linear regression on the samples of the regressor area. The method can be for example ordinary least-squares estimation, orthogonal matching pursuit, optimized orthogonal matching pursuit, etc. The prediction coefficients correspond to the a, b, c, . . . , z terms in the predictive model of Equation 2;
4. predict sample values of the target block using the set of prediction coefficients obtained a step 3:
   perform rounding and clipping of the predicted samples before predicting subsequent samples in the target area;
5. use prediction results of step 4 to choose in R-D sense (using Lagrangian cost functions, see Equation 1) the best sparsity (i.e., a sparsity number, i.e., number of non-zero prediction coefficients) out of all sets of prediction coefficients obtained at step 3;
6. use sparsity number obtained at step 5 to obtain the set of prediction coefficients, which are the best performing prediction coefficients or otherwise active prediction coefficients, and predict the sample values of the target area:
   perform rounding and clipping of the predicted samples before predicting subsequent samples in the target area;
7. encode an indication, for example the sparsity number obtained at step 5, or other parameters indicating the active prediction coefficients into the code stream.

The decoder, according to an example, is configured to:
1. obtain sample values of the regressor area (block(s) or region(s));
2. extract an indication, for example the sparsity number, or other parameters indicating the active prediction coefficients from the code stream;
3. obtain the prediction coefficients corresponding to the sparsity number of step 2 using the same method of linear regression as the encoder;
4. use the set of prediction coefficients obtained at step 3 to predict the sample values in the target area:
   the prediction coefficients correspond to the a, b, c, . . . , z terms in the predictive model of Equation 2;
   perform rounding and clipping of the predicted samples before predicting subsequent samples in the target area.

The following examples represent embodiments of an encoder and/or a decoder. Any of the following embodiments will apply to both encoder and decoder, unless otherwise mentioned.

According to an example embodiment, a target area refers to a set of sample values covering spatially equal areas at both the encoder and the decoder in some color component. The target area can be a square or rectangular block or any other shape, such as an arbitrary segmentation region.

According to an example embodiment, the regressor area refers to a set of sample values covering spatially equal areas at both the encoder and the decoder in one or more color components. The regressor area can be a square or rectangular block or any other shape, such as an arbitrary segmentation region. The regressor area may cover one or more color components.

According to an example embodiment, the regressor area for predicting samples for a chrominance component Cx includes areas from the luminance component and the chrominance component Cx.

According to an example embodiment, the regressor area for predicting samples for a chrominance component Cx includes areas from the chrominance component Cx and from another chrominance component Cy.

According to an example embodiment, the regressor area for predicting samples for a chrominance component Cx includes areas from the luminance component, the chrominance component Cx and from another chrominance component Cy.

According to an example embodiment, the regressor area for predicting samples for a chrominance component Cx includes one line of samples above the target block and one column of samples left of the target block in the same chrominance component Cx, and three lines of samples above the target block and three columns of samples left of the target block in the luminance component.

According to an example embodiment, the regressor area for predicting samples for a chrominance component Cx includes two lines of samples above the target block and two columns of samples left of the target block in the same chrominance component Cx, and three lines of samples above the target block and three columns of samples left of the target block in the luminance component.

According to an example embodiment, the regressor area for predicting samples for a chrominance component Cx includes one line of samples above the target block and/or one column of samples left of the target block in the same chrominance component Cx, and additional lines and columns in the luminance component. The one line or column of samples in the chrominance component Cx can be selected to be the closest lines or columns to the edge of the target block or can be selected to be further away from the edge. The one line or column of samples can also be generated from multiple lines or columns of samples by filtering means, for example by blending multiple lines or columns into one line or column.

According to an embodiment, the target and regressor areas can have various sizes and shapes, and the sizes and shapes of target and regressor areas used during encoding and decoding can be independent of each other with the sizes and shapes individually signalled by the encoder to the decoder using entropy-coded parameters.

According to an embodiment, the encoder is configured to decide the size and shape of the target area as part of the R-D (Rate-Distortion) optimization, or the target area can be based on some other criterion or defined as fixed.

According to an embodiment, the encoder is configured to decide the size, shape and location of the regressor area based on an inference criterion, such as the size and/or shape of the target area. Thus, according to an embodiment, the decoder is configured to use the same criterion to reconstruct the size, shape and location of the regressor area.

According to an embodiment, the scan-order of the samples in the regressor and target area is horizontal, i.e. raster scan. Causality of the predictor implies that only past values of same or earlier horizontal scan lines are used in the prediction of the current sample (x, y).

The causal linear predictor refers to a set of sample values and corresponding coefficients in the causal neighbourhood of the sample itself. A causal neighbourhood can be for example the sample values in the top, left, and top-left (i.e. north-west) spatial locations with respect to the sample, or any other causal combination. The causal neighbourhood may also contain sample values from previously decoded color components. In such a case, the samples may spatially correspond to the right, top-right and bottom-right neighbours but since the full color component has already been decoded, the predictor remains causal. Each spatial location corresponds to a variable in the linear regression model. Considering a sample value I_{x,y} located at spatial coordinates (x,y), x referring to the horizontal and y referring to the vertical directions, a causal predictor has a mathematical formulation of the following:

I_{x,y}=a·I_{x-1,y-1}+b·I_{x,y-1}+c·I_{x-1,y}+ . . . +z·B+ϵ, (Eq. 2)

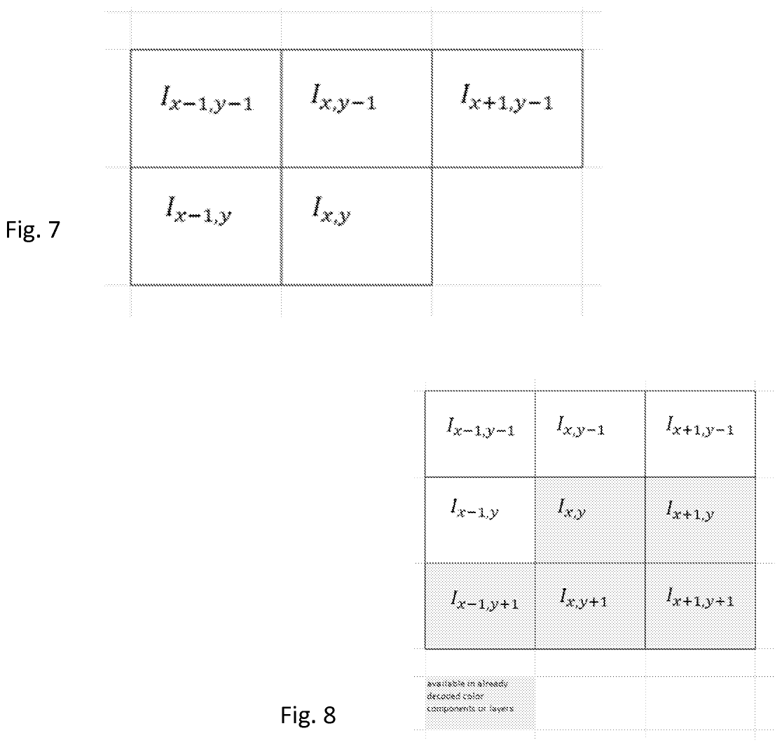

with any combination of past sample values (x+i, y+j), where i≤0, j≤0 explicitly noting that the current sample (x, y), i.e., (i,j)==(0,0) is not to operate as predictor. FIG. 7 illustrates an example of a causal predictor template.

In Equation 2, z·B represents the bias or intercept term of the linear regression model, and E represents the random noise-term. Many types of textures, and also less regular regions, can be expressed using statistics derived from an autoregressive process, and therefore a causal linear prediction scheme is well suited for prediction of these types of features in images and videos. During encoding and decoding, the coefficients a, b, c, . . . , z can be obtained adaptively using the sample values of the regressor area using linear regression as described below:

A linear prediction, such as the one presented in Equation 2, can be used in intra-prediction of video frames or still images. Intra prediction refers to prediction of the image data solely from sample values of the same video frame or the same still image. Temporally neighbouring video frames are not used in intra-prediction. Prediction of still images is therefore inherently intra. Recent intra video codecs and still image codecs often predict a block of samples using fixed interpolators operating on row(s) or column(s) or both of samples adjacent to the target block. This type of prediction works independently on each sample in the target block and disregards interactions between neighbouring samples within the target block. The fixed interpolators use only a few coefficients, and the coefficients are designed together with the encoder. Therefore, such a fixed interpolator cannot efficiently adapt the coefficients to statistics of the image data during encoding. A clear advantage over such a fixed scheme can be obtained by designing the interpolator adaptively for each target area during encoding based on past sample values and their statistics. When the interpolator is designed adaptively using already encoded (or decoded) samples, the prediction coefficients do not have to be signalled by the encoder to the decoder. Therefore, very complex interpolators having hundreds of coefficients can be used in target area prediction without any additional signalling overhead.

According to an embodiment, the regressor area may contain Nₛ number of samples and for each sample a causal neighbourhood contains N_{c} number of neighbouring samples. Each row of the regressor matrix A corresponds to a certain sample location in the regressor area and each column corresponds to a certain sample in the causal neighbourhood. The regressor matrix will therefore have the dimensions of Nₛ×(N_{c}+1), where an additional column of constant term has been added to represent the bias or intercept term B of the causal linear predictor. The samples of the regressor area are placed in Nₛ long column vector y. The full system of equations can be expressed as

Aw=y+ϵ

where w represents a set of coefficients and ϵ represents prediction noise. The coefficient w can be obtained using many types of linear regression tools such as ordinary least-squares estimation, orthogonal matching pursuit, optimized orthogonal matching pursuit, ridge regression, least absolute shrinkage and selection operator (LASSO), etc.

Embodiments of video or still image encoder and decoder share the same linear regression method for estimating w. An encoder according to an embodiment may operate with several linear regression methods and signal the most suitable variable to the embodiment of a decoder using entropy coding or any other means of coding. An embodiment of an encoder may use several criteria for deciding the winning candidate of the linear regression methods, and the criteria may include for example target area prediction error or computational complexity of the linear regression.

According to an embodiment, the linear regression method may vary within one image or video frame, or it may vary within a coded sequence of frames. An encoder according to an embodiment, may not always signal the linear regression method explicitly, since a decoder, according to an embodiment, may use inference to obtain the linear regression method using statistics obtained from neighbouring blocks within the frame or from previously decoded frames.

According to an embodiment, the linear regression method used to obtain the linear predictor for chroma component may be inherited from the luma component.

According to an embodiment, the linear regression method for any color component may be inherited from the already decoded color components.

The sparsity of the coefficient vector w refers to the number of non-zero coefficients in the vector w. Each coefficient in vector corresponds to a certain causal neighbour of the predicted sample (x, y). The non-zero elements of w constitute to the sparse support of the predictor. Using ordinary least-squares estimation, a full solution having N_{c}+1 non-zero coefficients can be obtained. However, in many cases the full solution overfits the coefficients to the sample values of the regressor area therefore performing poorly in prediction of the target area. A sparse solution involving only a few non-zero coefficients of w can be used to avoid the overfitting problem.

An encoder according to an embodiment may consider several sparse sets of coefficients for obtaining in R-D sense the best set of coefficients for prediction of the target area. The encoder will obtain K iterations for coefficient vector w, with each iteration representing certain level of sparseness. The encoder can consider a full search of I, . . . , N_{c}+1 sparsities or may consider only a subset of the full range.

According to an embodiment, the regressor area is considered to contain sample values having similar texture to the target area and can therefore be used to design a causal linear predictor (i.e., a set of coefficients) to be used for predicting the target area.

According to an embodiment, the causal linear predictor is designed based on iterative linear regression on the regressor area and therefore an embodiment of a decoder can obtain the same causal linear predictor using the sparsity number and regressor area without access to target area.

According to an embodiment, the R-D sense best performing sparsity number is signalled by an encoder to a decoder by encoding the sparsity number into the code stream using entropy coding or any other means of signalling.

According to an embodiment, the sparsity number is fixed for a slice, picture, group of pictures or a video sequence. The fixed sparsity number can be signalled for example in the slice header, in the picture header, in a parameter set, in some other syntax structure inside or outside of the video bitstream or it can be a pre-determined value.

According to an embodiment, the other parameters indicating the active coefficients consists of a flag indicating that regression-based prediction is used for a coding unit, prediction unit or a transform unit and all coefficients are active and may have non-zero values as a result of the regression process.

According to an embodiment, the other parameters indicating the active coefficients consists of a flag indicating that regression-based prediction is used for a coding unit, prediction unit or a transform unit and a specific subset of coefficients are active and may have non-zero values as a result of the regression process.

According to an embodiment, the sparsity number for chroma component may be inherited from the luma component.

According to an embodiment, the sparsity number for any color component may be inherited from the already decoded color components.

According to an embodiment, the sparsity number for color components can be obtained either independently for each component or jointly based on the performance over all color components. The advantage of the latter option is the reduced computational complexity.

According to an embodiment, an encoder may consider statistics (for example sparsities) of neighbouring target areas for inferring the sparsity K of the current target area. Therefore, an encoder according to an embodiment may use some algorithm or criterion to infer the proper sparsity K without actual R-D based search. Such an algorithm can be for example based on the size of the target area, the activity of intensity gradients in the regressor area, or inference based on statistics of K in past target areas.

An encoder according to an embodiment can maintain a list of most-probable values for K, and therefore is able signal K using an index in the most-probable list. In such a case, a decoder according to an embodiment shall maintain the same most-probable list and reconstruct K using the index obtained from the code stream.

An encoder according to an embodiment can obtain a processing speed-up by considering a sub-sampled set of samples in the regressor area. Such subsampling can consider for example only every other row of matrix A and vector y, or any other type of subsampling of data samples, such spatial subsampling prior to obtaining matrix A and vector y.

According to an embodiment, when causally predicting the target area, the predicted samples are rounded and then clipped to the proper sample value range obtained from the bit depth of the image or video data. Rounding and clipping operations are performed before any subsequent target samples are predicted. Different bit depths may be considered for different color components, i.e., the range used in the clipping operation is not necessarily the same for all color components.

According to an embodiment, the following pseudo-code illustrates the causal prediction scheme of the sample values in a rectangular target area with the upper-left corner of the target area located at (x₀,y₀), see FIG. 6, with the number of coefficients in w being N_{c}+1,

```
for y = y₀ to y₀ + target_area_height-1 {
  for x = x₀ to x₀ + target_area_width-1 {
    l_{x,y} = 0;
    for k = 0 to N_{c} − 1 {
      l_{x,y} += l_{x+i(k),y+j(k)} · w(k)
    }
    l_{x,y} += w(N_{c}) · B
    l_{x,y} = clip(round(l_{x,y}));
  }
}
```

An encoder or a decoder according to an embodiment can consider the samples of the target or regressor areas independently for each color component. Therefore, causal prediction can be performed independently over each of the color components. In video coding the color components may represent the three components of the RGB or YUV (e.g. YCbCr) colorspace but any other colorspace can be selected as well. The colorspace can be in any color format such as 4:4:4, 4:2:2 or 4:2:0.

An encoder according to an embodiment can consider the sets of coefficients obtained for past target areas as candidates for the set of coefficients w to be used in the prediction of the current target area. In this case, the encoder may store the past sets of coefficients into a library of predictors. An encoder according to an embodiment can subsequently access the predictor library and based on the R-D performance of the predictors, the encoder may or may not choose to use a set of coefficients from the predictor library to predict the current target area.

According to an embodiment, the predictor library may be updated on-line during encoding and decoding after processing either a single block (such as CU or PU) or a collection of blocks such as a CTU.

An encoder according to an embodiment may be configured to signal whether the predictor library is used for the current target area, and if used the encoder may signal, using entropy coding or other means of coding, an index to indicate which set of coefficients is selected from the predictor library. Therefore, a decoder according to an embodiment can obtain the same set of coefficients w during the decoding and prediction of the target area.

According to an embodiment, attributes of the regressor area may be signalled by the encoder to the decoder using entropy coding or any other means of coding. For example, the encoder may signal, whether to use both the above and left neighbouring blocks as regressor areas, or whether to use only one of them. An encoder according to an embodiment can for example try separately each one of the two neighbouring blocks or jointly both blocks to obtain best prediction performance. An encoder according to an embodiment will subsequently signal the attributes of the regressor area to the decoder.

According to an embodiment, the size of the predictor library can be either adaptive or fixed, and the predictor library can contain either the full set of past sets of coefficients, a certain number of recently obtained past sets of coefficients or any other configuration of past sets of coefficients.

According to an embodiment, the predictor library can be for example reorganized using spatial attributes, so that items (i.e., sets of coefficients corresponding to some earlier blocks) of the predictor library originating from close spatial proximity of the current target area are moved to beginning of the library thus reducing the code length of the library indices when using entropy coding such as arithmetic coding or fixed alphabet prefix coding for signalling. The spatial proximity can be evaluated using a norm, such as Euclidean or Manhattan norms, to rank the spatial distance of a previous block (or any spatial region corresponding to a library item) to the current target area or block.

According to an embodiment, the predictor library can be for example reorganized using move-to-front algorithm or any data adaptation algorithm to better model the recent statistics of the prediction process thus reducing the code length of the library indices when using fixed alphabet prefix coding for signalling.

An encoder according to an example embodiment and operating according to the present solution may perform the following steps when using the predictor library:
1. obtain sample values of the target area (block or region);
2. obtain sample values of the regressor area(s) (block(s) or region(s));
3. obtain at least one set of prediction coefficients using some method of linear regression (such as ordinary least-squares estimation, orthogonal matching pursuit, optimized orthogonal matching pursuit, etc.) on the samples of the regressor area. The prediction coefficients correspond to the a, b, c, . . . , z terms in the predictive model of Equation 2;
4. predict the sample values of the target block using the prediction coefficients obtained at step 3:
   perform rounding and clipping of the predicted samples before predicting subsequent samples in the target area;
5. predict the sample values of the target block using sets of prediction coefficients (each set corresponding to a certain library index) obtained from the predictor library:
   perform rounding and clipping of the predicted samples before predicting subsequent samples in the target area;
6. use prediction results of steps 4 and 5 and based on R-D comparison of the two prediction results, select either the best sparsity (i.e., a sparsity number, i.e., number of non-zero prediction coefficients) out of all sets of prediction coefficients obtained at step 3 or the predictor library index corresponding to the R-D sense best performing set of prediction coefficients in the predictor library;
7. based on the result of the R-D comparison at step 6, use either sparsity number obtained at step 6 or the best predictor library index obtained at step 6 to obtain the set of prediction coefficients, and predict the sample values of the target area:
   perform rounding and clipping of the predicted samples before predicting subsequent samples in the target area;
8. based on the result of the R-D comparison at step 6, encode either the sparsity number obtained at step 6 or the predictor library index obtained at step 6 into the code stream;
9. if no predictor library index is encoded at step 8, concatenate the set of prediction coefficients (corresponding to the R-D sense best sparsity number) into the predictor library.

A decoder according to an example embodiment and operating according to the present solution may perform the following steps when using the predictor library:
1. obtain sample values of the regressor area(s) (block(s) or region(s));
2. obtain several sets of prediction coefficients using the same method of linear regression as the encoder;
3. use the sparsity number extracted from the code stream or the predictor library index extracted from the code stream to select the best set of prediction coefficients as decided by the encoder;
4. use the set of prediction coefficients to predict the samples in the target area:
   the prediction coefficients correspond to the a, b, c, . . . z terms in the predictive model of Equation 2;
   perform rounding and clipping of the predicted samples before predicting subsequent samples in the target area;
5. if no predictor library index was extracted at step 3, concatenate the prediction coefficients into the predictor library.

According to an embodiment, the matrix A may contain additional columns in addition to the N_{c}+1 columns. Such columns may represent for example the first or second order surface parameterization based on the (x,y) spatial coordinates of the samples in the regressor area.

According to an embodiment a second order surface parametrization, will include five additional columns in the regressor matrix A representing the following surface modelling parameters: x, y, xy, x², y². Forward-selection algorithms, such as optimized orthogonal matching pursuit may consider the second order surface parameterization to fit the data in the target block better than the model obtained from the sample values I_{x-i, y-j} therefore increasing the prediction performance.

According to an embodiment, necessary information about additional prediction parameterization (such as whether to use first or second order parameterization or any other parameterization independent or dependent on sample data) may either be hardcoded to both the encoder and decoder or signalled by the encoder to the decoder using some means of coding such as entropy coding.

According to an embodiment, when sequentially encoding and decoding color components, the encoder and decoder may use previously decoded color components as additional columns in regressor matrix A. The final prediction may be formed as a summation of a sparse AR (current channel) and a sparse MA (previously decoded color components) predictions. Therefore, the prediction model follows an ARMA model. For such an embodiment of the prediction process an example of the causal predictor for color component c can be formulated as presented by following Equation 3:

I_{x,y,c}=a·I_{x-1,y-1,c}+b·I_{x,y-1,c}+c·I_{x-1,y,c}+d·I_{x,y,c-1}+e·I_{x-1,y,c-1}+f·I_{x+1,y+1,c-2}+z·B+ϵ,

and the pseudo-code for cross-component causal reconstruction over a rectangular target (see FIGS. 6 and 8) area can be formulated as,

```
for y = y₀ to y₀ + target_area_height-1 {
  for x = x₀ to x₀ + target_area_width-1 {
    l_{x,y,c} = 0;
    for k = 0 to N_{c} − 1 {
      for u = 0 to c − 1 {
        l_{x,y,c} += l_{x+i(k),y+j(k),u} · w(k + u · N_{c})
      }
      }
    l_{x,y,c} += w(N_{c}) · B
    l_{x,y,c} = clip(round(l_{x,y,c}));
  }
}
```

where for simplicity it is assumed that c>0. Note, that in Equation 3 a previously decoded color component can be referenced in spatially non-causal manner as the term I_{x+1,y+1,c-1} illustrates. However, since the color component c−1 has already been decoded, the predictor remains causal. FIG. 8 illustrates an example of a spatially non-causal predictor template where the current sample value and spatially succeeding sample values of already decoded color components or layers have been highlighted.

In the above embodiment of causal cross-component prediction as formulated in Equation 3, unlike in Equation 2, the predictor may use the samples corresponding to the current and future (x,y) locations (i.e., when i≥0 and j≥0) of the already decoded color components, see FIG. 8.

An encoder or a decoder according to an embodiment may use the ARMA prediction model for cross-component prediction for any color format, such as YUV (i.e., YCbCr) or RGB 444, 420, 422, by properly subsampling the color components during cross-component prediction.

An encoder or a decoder according to an embodiment may use the MA (without the AR process) prediction model for cross-component prediction for any color format, such as YUV (i.e., YCbCr) or RGB 444, 420, 422, by properly subsampling the color components during cross-component prediction.

According to an embodiment when sequentially encoding and decoding multiple layers of video or image data, the encoder and decoder may use previously decoded layers as additional columns in the regressor matrix A. For example, an embodiment may use samples from a decoded base layer as additional columns in the regression matrix for obtaining the prediction coefficients for a target area in an enhancement layer.

In the above embodiment of cross-layer prediction the predictor may use samples corresponding to the current (x, y) and future locations (i.e., when i≥0 and j≥0) of the already decoded layers, see FIG. 8.

An encoder or decoder according to an embodiment may use AR, MA, or ARMA prediction models for cross-layer prediction.

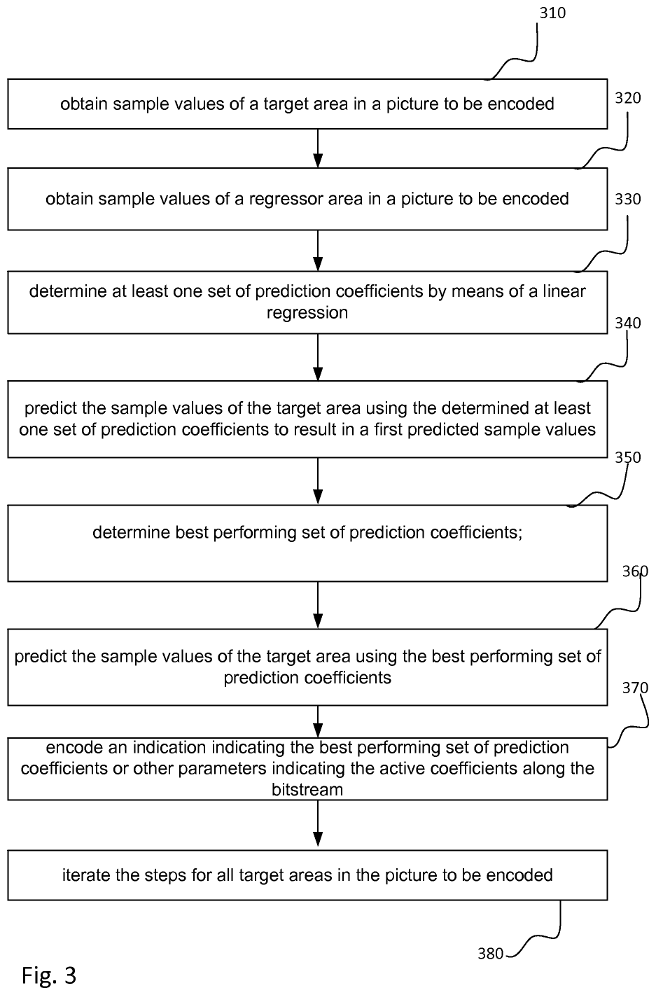

The method for encoding according to an embodiment is shown in FIG. 3. The method generally comprises
obtaining 310 sample values of a target area in a picture to be encoded;
obtaining 320 sample values of a regressor area in a picture to be encoded;
determining 330 at least one set of prediction coefficients by means of a linear regression;
predicting 340 the sample values of the target area using the determined at least one set of prediction coefficients to result in a first predicted sample values;
determining 350 best performing set of prediction coefficients;
predicting 360 the sample values of the target area using the best performing set of prediction coefficients;
encoding 370 an indication indicating the best performing set of prediction coefficients or other parameters indicating the active coefficients along the bitstream, and
iterating 380 the steps for all target areas in the picture to be encoded.

Each of the steps can be implemented by a respective module of a computer system.

An apparatus according to an embodiment comprises means for obtaining sample values of a target area in a picture to be encoded; means for obtaining sample values of a regressor area in a picture to be encoded; means for determining at least one set of prediction coefficients by means of a linear regression; means for predicting the sample values of the target area using at least the determined at least one set of prediction coefficients to result in a first predicted sample values; means for determining a best performing set of prediction coefficients; means for predicting the sample values of the target area using the best performing set of prediction coefficients; means for encoding an indication indicating the best performing set of prediction coefficients or other parameters indicating the active coefficients along the bitstream, and means for iterating the steps for all target areas in the picture to be encoded. The means comprises at least one processor, and a memory including a computer program code, wherein the processor may further comprise processor circuitry. The memory and the computer program code are configured to, with the at least one processor, cause the apparatus to perform the method of FIG. 3 according to various embodiments.

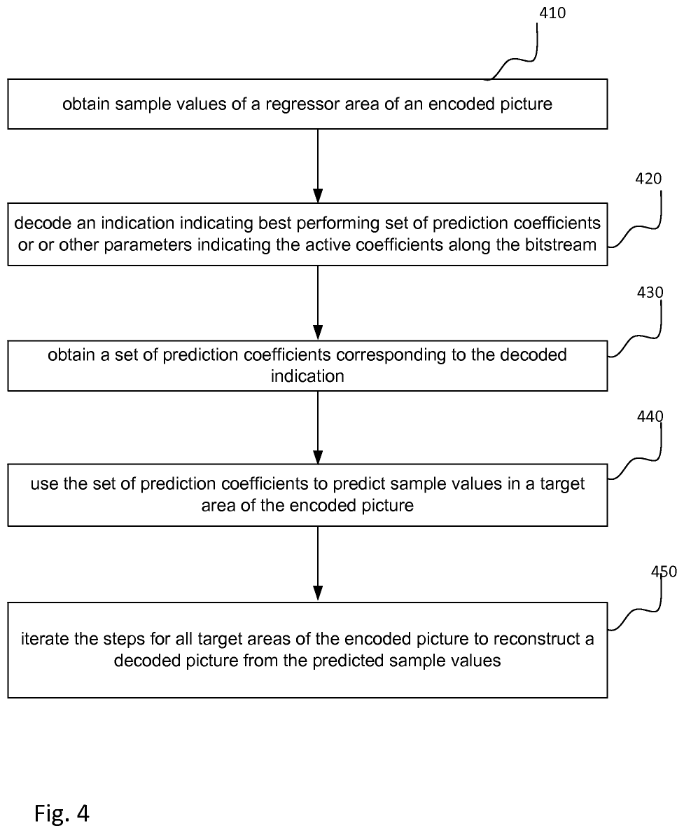

The method for decoding according to an embodiment is shown in FIG. 4. The method generally comprises
obtaining 410 sample values of a regressor area of an encoded picture;
decoding 420 an indication indicating best performing set of prediction coefficients or other parameters indicating the active coefficients along the bitstream;
obtaining 430 a set of prediction coefficients corresponding to the decoded indication;
using 440 the set of prediction coefficients to predict sample values in a target area of the encoded picture; and
iterating 450 the steps for all target areas of the encoded picture to reconstruct a decoded picture from the predicted sample values.

Each of the steps can be implemented by a respective module of a computer system.

An apparatus according to an embodiment comprises means for obtaining sample values of a regressor area of an encoded picture; means for decoding an indication indicating best performing set of prediction coefficients or other parameters indicating the active coefficients along the bitstream; means for obtaining a set of prediction coefficients corresponding to the decoded indication; means for using the set of prediction coefficients to predict sample values in a target area of the encoded picture; and means for iterating the steps for all target areas of the encoded picture to reconstruct a decoded picture from the predicted sample values. The means comprises at least one processor, and a memory including a computer program code, wherein the processor may further comprise processor circuitry. The memory and the computer program code are configured to, with the at least one processor, cause the apparatus to perform the method of FIG. 4 according to various embodiments.

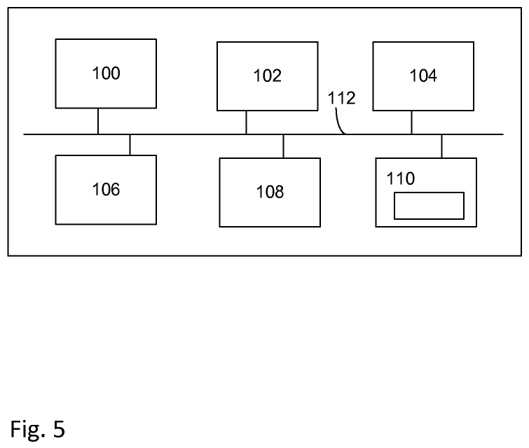

FIG. 5 shows an example of an apparatus. The generalized structure of the apparatus will be explained in accordance with the functional blocks of the system. Several functionalities can be carried out with a single physical device, e.g. all calculation procedures can be performed in a single processor if desired. A data processing system of an apparatus according to an example of FIG. 5 comprises a main processing unit 100, a memory 102, a storage device 104, an input device 106, an output device 108, and a graphics subsystem 110, which are all connected to each other via a data bus 112. A client may be understood as a client device or a software client running on an apparatus.

The main processing unit 100 is a processing unit arranged to process data within the data processing system. The main processing unit 100 may comprise or be implemented as one or more processors or processor circuitry. The memory 102, the storage device 104, the input device 106, and the output device 108 may include other components as recognized by those skilled in the art. The memory 102 and storage device 104 store data in the data processing system 100. Computer program code resides in the memory 102 for implementing, for example, machine learning process. The input device 106 inputs data into the system while the output device 108 receives data from the data processing system and forwards the data, for example to a display. While data bus 112 is shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of embodiments. A computer program product according to an embodiment can be embodied on a non-transitory computer readable medium. According to another embodiment, the computer program product can be downloaded over a network in a data packet.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-13. (canceled)

14. A method, comprising: obtaining sample values of a target area in a picture to be encoded; obtaining sample values of a regressor area in a picture to be encoded; determining at least one set of prediction coefficients by means of a linear regression; predicting the sample values of the target area using the determined at least one set of prediction coefficients to result in a first predicted sample values; determining best performing set of prediction coefficients; predicting the sample values of the target area using the best performing set of prediction coefficients; encoding an indication indicating the best performing set of prediction coefficients or other parameters indicating the active coefficients along the bitstream, and iterating the steps for all target areas in the picture to be encoded.

15. The method according to claim 14, wherein the target area is a set of sample values covering spatially equal areas at an encoder and a decoder in a color component.

16. The method according to claim 14, wherein the regressor area is a set of sample values covering spatially equal areas at an encoder and a decoder in one or more color components.

17. The method according to claim 14, further comprising: deciding size and shape of the target area; and deciding size, shape and location of the regressor area.

18. The method according to claim 14, wherein the best performing set of prediction coefficients is determined from said at least one set of prediction coefficients.

19. The method according to claim 18, wherein the linear regression for a picture component is inherited from another picture component.

20. The method according to claim 14, further comprising: predicting the sample values of the target area using sets of coefficients stored in a predictor library.

21. The method according to claim 20, wherein the best performing set of coefficients is determined from the predictor library storing past sets of coefficients.

22. An apparatus comprising: at least one processor; and at least one non-transitory memory including computer program code; wherein the at least one memory and the computer program code are configured to, with the at least one processor, cause the apparatus at least to: obtain sample values of a target area in a picture to be encoded; obtain sample values of a regressor area in a picture to be encoded; determine at least one set of prediction coefficients by means of a linear regression; predict the sample values of the target area using at least the determined at least one set of prediction coefficients to result in a first predicted sample values; determine a best performing set of prediction coefficients; predict the sample values of the target area using the best performing set of prediction coefficients; encode an indication indicating the best performing set of prediction coefficients or other parameters indicating the active coefficients along the bitstream, and iterate the steps for all target areas in the picture to be encoded.

23. The apparatus according to claim 22, wherein the target area is a set of sample values covering spatially equal areas at an encoder and a decoder in a color component.

24. The apparatus according to claim 22, wherein the regressor area is a set of sample values covering spatially equal areas at an encoder and a decoder in one or more color components.

25. The apparatus of claim 22, wherein the at least one memory and the computer program code are further configured to, with the at least one processor, cause the apparatus at least to: decide size and shape of the target area; and decide size, shape and location of the regressor area.

26. The apparatus according to claim 22, wherein the best performing set of prediction coefficients is determined from said at least one set of prediction coefficients.

27. The apparatus according to claim 26, wherein the linear regression for a picture component is inherited from another picture component.

28. The apparatus of claim 22, wherein the at least one memory and the computer program code are further configured to, with the at least one processor, cause the apparatus at least to: predict the sample values of the target area using sets of coefficients stored in a predictor library.

29. The apparatus according to claim 28, wherein the best performing set of coefficients is determined from the predictor library storing past sets of coefficients.

30. A method comprising: obtaining sample values of a regressor area of an encoded picture; decoding an indication indicating best performing set of prediction coefficients or other parameters indicating the active coefficients along the bitstream; obtaining a set of prediction coefficients corresponding to the decoded indication; using the set of prediction coefficients to predict sample values in a target area of the encoded picture; and iterating the steps for all target areas of the encoded picture to reconstruct a decoded picture from the predicted sample values.

31. An apparatus comprising: at least one processor; and at least one non-transitory memory including computer program code; wherein the at least one memory and the computer program code are configured to, with the at least one processor, cause the apparatus at least to: obtain sample values of a regressor area of an encoded picture; decode an indication indicating best performing set of prediction coefficients or other parameters indicating the active coefficients along the bitstream; obtain a set of prediction coefficients corresponding to the decoded indication; use the set of prediction coefficients to predict sample values in a target area of the encoded picture; and iterate the steps for all target areas of the encoded picture to reconstruct a decoded picture from the predicted sample values.
